(19) United States
(12) Patent Application Publication
(10) Pub. No.: US 2015/0261677 A1
(43) Pub. Date: Sep. 17, 2015

(54) Apparatus and Method of Resolving Protocol Conflicts in an Unordered Network

(71) Applicant: Silicon Graphics International Corp., Milpitas, CA (US)

(72) Inventor: Michael E. Malewicki, Eau Claire, WI (US)

(21) Appl. No.: 14/644,629

(22) Filed: Mar. 11, 2015

Related U.S. Application Data
(60) Provisional application No. 61/951,792, filed on Mar. 12, 2014.

(51) Int. Cl. G06F 12/08

(52) U.S. Cl. CPC G06F 12/0831; G06F 2212/621

(57) ABSTRACT

An apparatus and method of accessing data in a memory in a multi-node, high performance computing system has a requesting agent and a home agent. The requesting agent is a member of a first node of the high performance computing system, while the home agent is a member of a second node of the high performance computing system. The home agent forwards data in a specified memory toward the requesting agent across the unordered network, and determines that a snoop request is to be sent to the requesting agent. After determining that the requesting agent has received the requested data in the specified memory of the second node, the home agent forwards the snoop request to the requesting agent across the unordered network.

### PRIORITY

This patent application claims priority from provisional U.S. patent application No. 61/951,792, filed Mar. 12, 2014 entitled, “APPARATUS AND METHOD OF RESOLVING PROTOCOL CONFLICTS IN AN UNORDERED NETWORK,” and naming Michael E. Malewicki as inventor, the disclosure of which is incorporated herein, in its entirety, by reference.

### FIELD OF THE INVENTION

The invention generally relates to high performance computing systems and, more particularly, the invention relates to resolving protocol conflicts in a high performance computing system.

### BACKGROUND OF THE INVENTION

Large-scale shared memory multi-processor computer systems, such as high-performance computing systems, typically have a many processing nodes (e.g., with one or more microprocessors and local memory) that cooperate to perform a common task. For example, such computer systems may have some number of nodes that cooperate to multiply a large matrix. To do this in a rapid and efficient manner, such computer systems typically divide the task into discrete parts that each are executed by one of the nodes. All of the nodes are synchronized (e.g., using barrier variables) so that they concurrently execute their corresponding steps of the task.

Many high performance computing systems are considered to be shared memory systems because, among other things, their nodes share data from their local memories with processors on other nodes. Undesirably, however, many processors sharing data across the fabric of a high performance computing system can create inconsistent data. The art has responded to this problem by developing a number of schemes for maintaining data coherency between the different nodes and their memories. Data and cache coherency schemes thus manage conflicts and are intended to maintain data consistency.

When a “new processor” (e.g., another processor on another node) requests access to “home memory” that is currently in use/controlled by another node (e.g., a “current processor”), a “home agent” typically forwards a well-known “snoop request” to the current processor. As known by those in the art, a snoop request requires the current processor to release control of the data. Accordingly, the current processor typically responds to the snoop request by forwarding the updated data back to the home agent, and releasing control of that data/memory.

Sometimes, the home agent sends the snoop request to the current processor before the current processor actually receives the data from the memory. In unordered networks within high performance computing systems, such a situation undesirably can produce intermittent data flow stoppages or system slow-downs.

### SUMMARY OF VARIOUS EMBODIMENTS

In accordance with one embodiment of the invention, an apparatus and method of accessing data in a memory in a multi-node, high performance computing system has a requesting agent and a home agent. The requesting agent is a member of a first node of the high performance computing system, while the home agent is a member of a second node of the high performance computing system. The requesting agent is configured to forward a data request to the home agent across an unordered network within the high performance computing system. The data request is arranged to request data in specified memory of the second node of the high performance computing system. The home agent forwards the data in the specified memory toward the requesting agent across the unordered network, and determines that a snoop request is to be sent to the requesting agent. The snoop request is to be forwarded to the requesting agent after the home agent forwards the data in the specified memory toward the requesting agent. After it determines that the requesting agent has received the requested data in the specified memory of the second node, the home agent forwards the snoop request to the requesting agent across the unordered network (in response to determining that the requesting agent has received the requested data in the specified memory).

The requesting agent may forward an acknowledgement message toward the home agent across the unordered network. The acknowledgement message preferably has information indicating that the requesting agent has received the requested data in the specified memory of the second node. Receipt of the acknowledgement message by the home agent enables the home agent to determine that the requesting agent has received the requested data. The requesting agent also may forward a snoop response message toward the home agent after receipt of the snoop request. Among other things, the snoop response message may indicate that the requesting agent has released control of the specified memory.

The high performance computing system may have at least one other requesting agent (i.e., requesting access to the specified memory). In that case, the home agent may determine whether one or more of the other requesting agents are requesting access to the specified memory. The home agent then may responsively forward the snoop request without determining that the requesting agent has received the requested data in the specified memory if the home agent determines that no other requesting agents are requesting access to the specified memory. In some embodiments, the home agent forwards the data in the specified memory as a part of a data message having a field indicating whether one or more other requesting agents are requesting access to the specified memory.

When using the data message having the field, the requesting agent may generate an acknowledgement message toward the home agent only if the field indicates that one or more other requesting agents are requesting access to the specified memory. As with other embodiments, the acknowledgement message has information indicating that the requesting agent has received the requested data in the specified memory of the second node. Receipt of the acknowledgement message by the home agent enables the home agent to determine that the requesting agent has received the requested data.

The home agent preferably is part of a process agent within the second node. Accordingly, the home agent in this case may manage the specified memory of the second node. Moreover, the unordered network is configured to forward messages between agents in different nodes without the home agent maintaining a record of the order of agent request messages relating to requests for data in the specified memory.

After receiving the data of the specified memory, the requesting agent may control processing of the data of the specified memory at least until receipt of the snoop request from the home agent. As with other embodiments, receipt of the snoop request causes the requesting agent to relinquish control of the data of the specified memory.

In accordance with another embodiment, a high performance computing system has a requesting agent in a first node, a home agent in a second node, a specified memory in the second node, and an unordered network configured to permit electronic communication between the requesting agent and the home agent. The requesting agent is configured to forward a data request to the home agent across the unordered network within the high performance computing system. The data request is arranged to request data in the specified memory of the second node of the high performance computing system.

The home agent is configured to:

a) selectively forward the data in the specified memory across the unordered network,

b) determine whether a snoop request is to be sent to the requesting agent,

c) hold the snoop request if i) the home agent has forwarded the data in the specified memory toward the requesting agent and i) the home agent has not determined whether the requesting agent has received the data in the specified memory, and

d) forward the snoop request across the unordered network after determining that the requesting agent has received the data in the specified memory.

Illustrative embodiments of the invention are implemented as a computer program product having a computer usable medium with computer readable program code thereon. The computer readable code may be read and utilized by a computer system in accordance with conventional processes.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 schematically shows a logical view of an HPC system in accordance with one embodiment of the present invention.

FIG. 2 schematically shows a physical view of the HPC system of FIG. 1.

FIG. 3 schematically shows details of a blade chassis of the HPC system of FIG. 1.

FIG. 4 schematically shows a logical view of an unordered network, within the HPC system of FIG. 1, that may be used in accordance with illustrative embodiments of the invention.

FIG. 5 schematically shows a home agent configured in accordance illustrative embodiments of the invention.

FIG. 6 schematically shows a timing diagram illustrating a problem with the prior art.

FIG. 7 shows a process of managing access to cash in accordance with illustrative embodiments of the invention.

FIG. 8 schematically shows a second timing diagram for accessing cash in accordance with illustrative embodiments of the invention.

### DESCRIPTION OF ILLUSTRATIVE EMBODIMENTS

In illustrative embodiments, a home agent manages memory access within a node of an unordered, high-performance computing (“HPC”) system in a manner that mitigates the risk of intermittent data flow stoppages or system slow-downs. Specifically, as commonly happens, a requesting agent in the HPC may request access to data stored in memory managed by a home agent. When granted, some skilled in the art may consider this request as giving the requesting agent “control” of the specific portion of the memory having the requested data. This control often is temporary.

Thus, when it takes control away from the requesting agent, the home agent sends a well-known “snoop request” to the requesting agent. To improve system performance, the home agent is configured to send the snoop request only in one of two circumstances: 1) after the home agent confirms that the requesting agent has received the requested data (e.g., through an acknowledgement message received from the requesting agent), or 2) if the home agent has not yet sent the data to the requesting agent.

Accordingly, if the requesting agent receives a snoop request before receiving the requested data, it is configured to promptly respond to the snoop request, effectively relinquishing control of the data. This prompt response can happen without causing system problems because the requesting agent “knows” that it has either used the data (e.g., otherwise it would not have sent the acknowledgement message), or the home agent has not sent the data. Details of illustrative embodiments are discussed below.

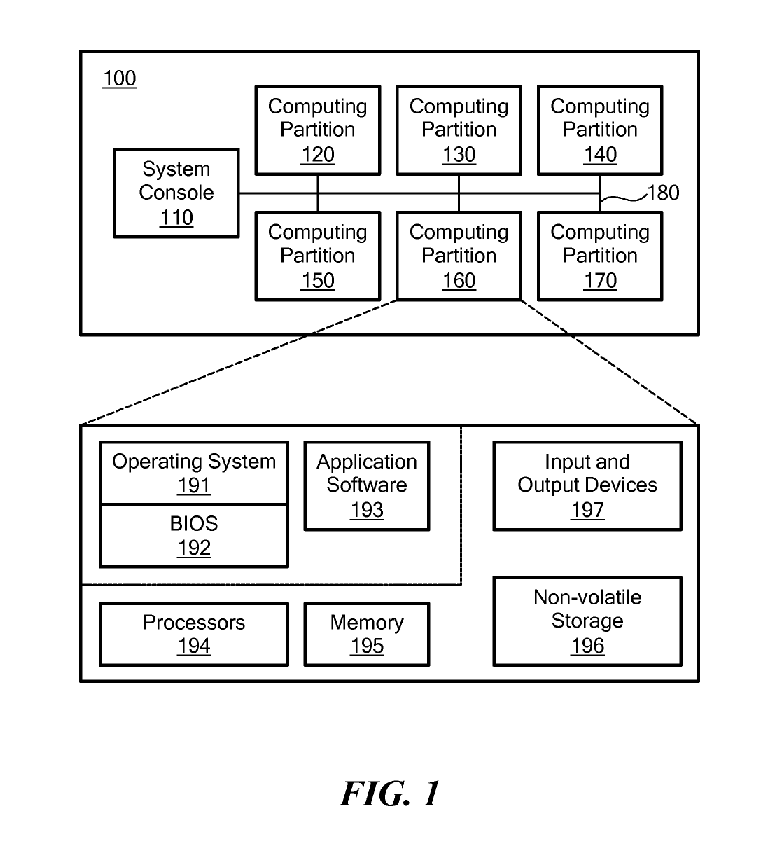

Many of the figures and much of the discussion below relate to embodiments implemented in a high performance computing (“HPC”) system environment. FIG. 1 schematically shows a logical view of an exemplary high-performance computing system 100 that may be used with illustrative embodiments of the present invention. Specifically, as known by those in the art, a “high-performance computing system,” or “HPC system,” is a computing system having a plurality of modular computing resources that are tightly coupled so that processors may access remote data directly using a common memory address space. Indeed, the specific implementation of FIGS. 1-3 are illustrative of one of a wide variety of HPC systems that may implement illustrative embodiments. Accordingly, the HPC system of FIGS. 1-3 are discussed for illustrative purposes and are not intended to limit all embodiments.

To those ends, the HPC system 100 includes a number of logical computing partitions 120, 130, 140, 150, 160, 170 for providing computational resources, and a system console 110 for managing the plurality of partitions 120-170. A “computing partition” (or “partition”) in an HPC system is an administrative allocation of computational resources that runs a single operating system instance and has a common memory address space. Partitions 120-170 may communicate with the system console 110 using a logical communication network 180. A system user, such as a scientist or engineer who desires to perform a calculation, may request computational resources from a system operator, who uses the system console 110 to allocate and manage those resources. The HPC system 100 may have any number of computing partitions that are administratively assigned as described in more detail below, and often has only one partition that encompasses all of the available computing resources. Accordingly, this figure should not be seen as limiting the scope of the invention.

Each computing partition, such as partition 160, may be viewed logically as if it were a single computing device, akin to a desktop computer. Thus, the partition 160 may execute software, including a single operating system (“OS”) instance 191 that uses a basic input/output system (“BIOS”) 192 as these are used together in the art, and application software 193 for one or more system users.

Accordingly, as also shown in FIG. 1, a computing partition has various hardware allocated to it by a system operator, including one or more processors 194, volatile memory 195, non-volatile storage 196, and input and output (“I/O”) devices 197 (e.g., network cards, video display devices, keyboards, and the like). However, in HPC systems like the embodiment in FIG. 1, each computing partition has a great deal more processing power and memory than a typical desktop computer. The OS software may include, for example, a Windows® operating system by Microsoft Corporation of Redmond, Washington, or a Linux operating system. Moreover, although the BIOS may be provided as firmware by a hardware manufacturer, such as Intel Corporation of Santa Clara, Calif., it is typically customized according to the needs of the HPC system designer to support high-performance computing, as described below in more detail.

As part of its system management role, the system console 110 acts as an interface between the computing capabilities of the computing partitions 120-170 and the system operator or other computing systems. To that end, the system console 110 issues commands to the HPC system hardware and software on behalf of the system operator that permit, among other things: 1) booting the hardware, 2) dividing the system computing resources into computing partitions, 3) initializing the partitions, 4) monitoring the health of each partition and any hardware or software errors generated therein, 5) distributing operating systems and application software to the various partitions, 6) causing the operating systems and software to execute, 7) backing up the state of the partition or software therein, 8) shutting down application software, and 9) shutting down a computing partition or the entire HPC system 100. These particular functions are described in more detail in the section below entitled “System Operation.”

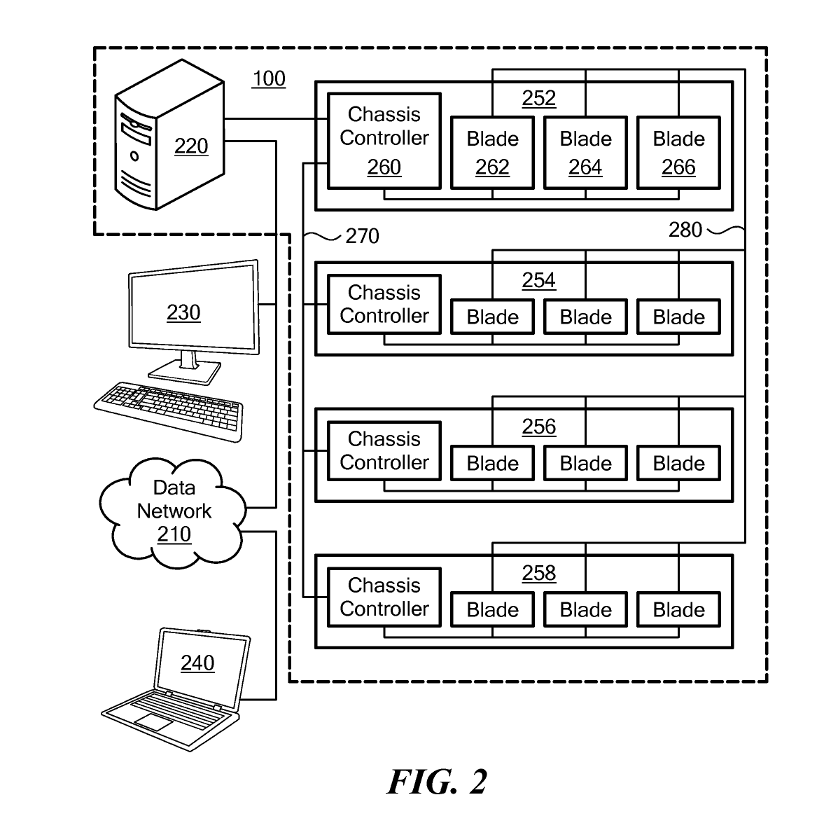

FIG. 2 schematically shows a physical view of a high performance computing system 100 in accordance with the embodiment of FIG. 1. The hardware that comprises the HPC system 100 of FIG. 1 is surrounded by the dashed line. The HPC system 100 is connected to an enterprise data network 210 to facilitate user access.

The HPC system 100 includes a system manager (“SM”) 220 that performs the functions of the system console 110. The SM 220 may be implemented as a desktop computer, a server computer, or other similar computing device, provided either by the enterprise or the HPC system designer, and includes software necessary to control the HPC system 100 (i.e., the system console software).

The HPC system 100 is accessible using the data network 210, which may include any data network known in the art, such as an enterprise local area network (“LAN”), a virtual private network (“VPN”), the Internet, or the like, or a combination of these networks. Any of these networks may permit a number of users to access the HPC system resources remotely and/or simultaneously. For example, the SM 220 may be accessed by an enterprise computer 230 by way of remote login using tools known in the art such as Windows® Remote Desktop Services or the Unix secure shell. If the enterprise is so inclined, access to the HPC system 100 may be provided to a remote computer 240. The remote computer 240 may access the HPC system by way of a login to the SM 220 as just described, or using a gateway or proxy system as is known to persons in the art.

The hardware computing resources of the HPC system 100 (e.g., the processors, memory, non-volatile storage, and I/O devices shown in FIG. 1) are provided collectively by one or more “blade chassis,” such as blade chassis 252, 254, 256, 258 shown in FIG. 2, that are managed and allocated into computing partitions. A blade chassis is an electronic chassis that is configured to house, power, and provide high-speed data communications between a plurality of stackable, modular electronic circuit boards called “blades.” Each blade includes enough computing hardware to act as a standalone computing server. The modular design of a blade chassis permits the blades to be connected to power and data lines with a minimum of cabling and vertical space.

Accordingly, each blade chassis, for example blade chassis 252, has a chassis management controller 260 (also referred to as a “chassis controller” or “CMC”) for managing system functions in the blade chassis 252, and a number of blades 262, 264, 266 for providing computing resources. Each blade (generically identified below by reference number “26”), for example blade 262, contributes its hardware computing resources to the collective total resources of the HPC system 100. The SM 220 manages the hardware computing resources of the entire HPC system 100 using the chassis controllers, such as chassis controller 260, while each chassis controller in turn manages the resources for just the blades 26 in its blade chassis. The chassis controller 260 is physically and electrically coupled to the blades 262-266 inside the blade chassis 252 by means of a local management bus 268. The hardware in the other blade chassis 254-258 is similarly configured.

The chassis controllers communicate with each other using a management connection 270. The management connection 270 may be a high-speed LAN, for example, running an Ethernet communication protocol, or other data bus. By contrast, the blades 26 communicate with each other using a computing connection 280. To that end, the computing connection 280 illustratively has a high-bandwidth, low-latency system interconnect, such as NumaLink, developed by Silicon Graphics International Corp. of Milpitas, Calif.

The blade chassis 252, the computing hardware of its blades 262-266, and the local management bus 268 may be provided as known in the art. However, the chassis controller 260 may be implemented using hardware, firmware, or software provided by the HPC system designer. Each blade 26 provides the HPC system 100 with some quantity of processors, volatile memory, non-volatile storage, and I/O devices that are known in the art of standalone computer servers. However, each blade 26 also has hardware, firmware, and/or software to allow these computing resources to be grouped together and treated collectively as computing partitions.

While FIG. 2 shows an HPC system 100 having four chassis and three blades in each chassis, it should be appreciated that these figures do not limit the scope of the invention. An HPC system may have dozens of chassis and hundreds of blades 26; indeed, HPC systems often are desired because they provide very large quantities of tightly-coupled computing resources.

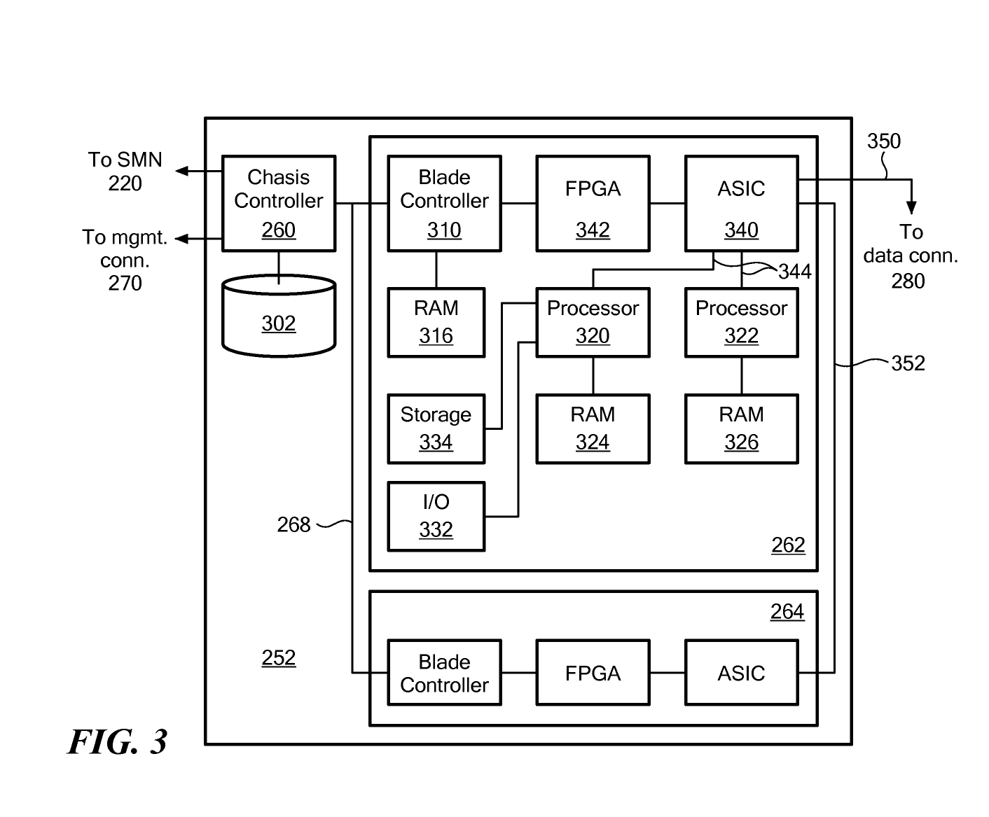

FIG. 3 schematically shows a single blade chassis 252 in more detail. In this figure, parts not relevant to the immediate description have been omitted. The chassis controller 260 is shown with its connections to the SM 220 and to the management connection 270. The chassis controller 260 may be provided with a chassis data store 302 for storing chassis management data. In some embodiments, the chassis data store 302 is volatile random access memory (“RAM”), in which case data in the chassis data store 302 are accessible by the SM 220 so long as power is applied to the blade chassis 252, even if one or more of the computing partitions has failed (e.g., due to an OS crash) or a blade 26 has malfunctioned. In other embodiments, the chassis data store 302 is non-volatile storage such as a hard disk drive (“HDD”) or a solid state drive (“SSD”). In these embodiments, data in the chassis data store 302 are accessible after the HPC system has been powered down and rebooted.

FIG. 3 shows relevant portions of specific implementations of the blades 262 and 264 for discussion purposes. The blade 262 may be considered to form its own node (or multiple nodes within the blade 262), and include a blade management controller 310 (also called a “blade controller” or “BMC”) that executes system management functions at a blade level, in a manner analogous to the functions performed by the chassis controller at the chassis level. The blade controller 310 may be implemented as custom hardware, designed by the HPC system designer to permit communication with the chassis controller 260. In addition, the blade controller 310 may have its own RAM 316 to carry out its management functions. The chassis controller 260 communicates with the blade controller of each blade 26 using the local management bus 268, as shown in FIG. 3 and the previous figures.

The blade 262 also includes one or more processors 320, 322 that are connected to RAM 324, 326. The blade 262 may be alternately configured so that multiple processors may access a common set of RAM on a single bus, as is known in the art. It should also be appreciated that processors 320, 322 may include any number of central processing units (“CPUs”) or cores, as is known in the art. The processors 320, 322 in the blade 262 are connected to other items, such as a data bus that communicates with I/O devices 332, a data bus that communicates with non-volatile storage 334, and other buses commonly found in standalone computing systems. (For clarity, FIG. 3 shows only the connections from processor 320 to some devices.) The processors 320, 322 may be, for example, Intel® Core™ processors manufactured by Intel Corporation. The I/O bus may be, for example, a PCI or PCI Express (“PCIe”) bus. The storage bus may be, for example, a SATA, SCSI, or Fibre Channel bus. It will be appreciated that other bus standards, processor types, and processor manufacturers may be used in accordance with illustrative embodiments of the present invention.

Each blade 26 (e.g., the blades 262 and 264) includes an application-specific integrated circuit 340 (also referred to as an “ASIC”, “hub chip”, or “hub ASIC”) that controls much of its functionality—i.e., the functionality of the node implemented as the blade 26. More specifically, to logically connect the processors 320, 322, RAM 324, 326, and other devices 332, 334 together to form a managed, multi-processor, coherently-shared distributed-memory HPC system, the processors 320, 322 are electrically connected to the hub ASIC 340. The hub ASIC 340 thus provides an interface between the HPC system management functions generated by the SM 220, chassis controller 260, and blade controller 310, and the computing resources of the blade 262.

In this connection, the hub ASIC 340 connects with the blade controller 310 by way of a field-programmable gate array (“FPGA”) 342 or similar programmable device for passing signals between integrated circuits. In particular, signals are generated on output pins of the blade controller 310, in response to commands issued by the chassis controller 260. These signals are translated by the FPGA 342 into commands for certain input pins of the hub ASIC 340, and vice versa. For example, a “power on” signal received by the blade controller 310 from the chassis controller 260 requires, among other things, providing a “power on” voltage to a certain pin on the hub ASIC 340; the FPGA 342 facilitates this task.

The hub chip 340 in each blade 26 also provides connections to other blades 26 for high-bandwidth, low-latency data communications. Thus, the hub chip 340 includes a link 350 to the computing connection 280 that connects different blade chassis. This link 350 may be implemented using networking cables, for example. The hub ASIC 340 also includes connections to other blades 26 in the same blade chassis 252. The hub ASIC 340 of blade 262 connects to the hub ASIC 340 of blade 264 by way of a chassis computing connection 352. The chassis computing connection 352 may be implemented as a data bus on a backplane of the blade chassis 252 rather than using networking cables, advantageously allowing the very high speed data communication between blades 26 that is required for high-performance computing tasks. Data communication on both the inter-chassis computing connection 280 and the intra-chassis computing connection 352 may be implemented using the NumaLink protocol or a similar protocol.

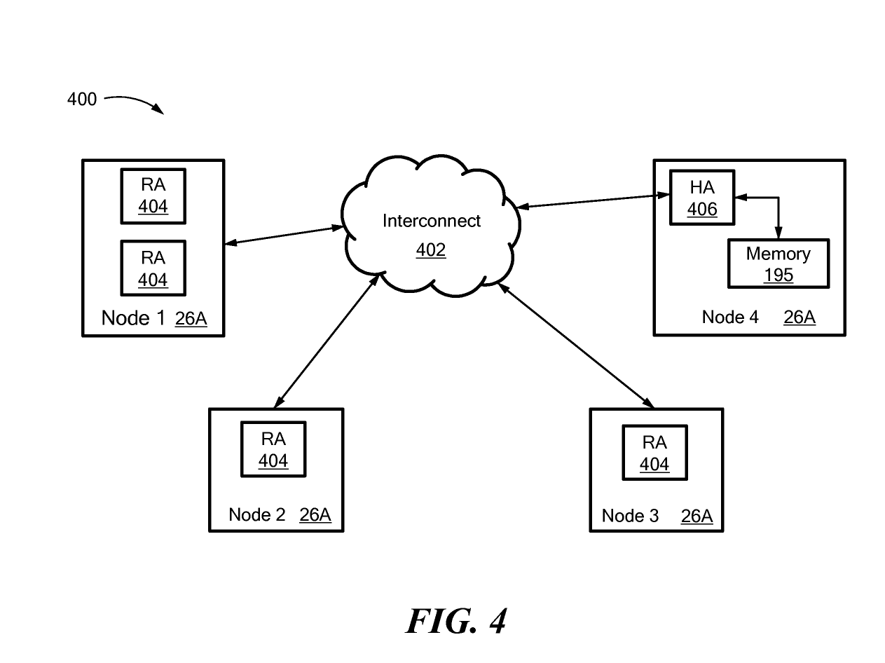

FIG. 4 schematically shows an unordered network 400, within the HPC system 100, which interconnects a plurality of nodes 26A configured in accordance with illustrative embodiments of the invention. As known by those skilled in the art, an unordered network 400 within an HPC system 100 permits messages to travel along any path through its communication network/fabric—it does not necessarily have a prescribed path between end-points. For example, messages can re-route around congestion points or in ways that are not anticipated when they are transmitted. Messages thus transmit through the unordered network 400 in a way that is not prescribed when they are initially sent. The behavior resembles a network using the Internet Protocol (“IP”), such as the Internet. One distinction, however, is that this network of FIG. 4 is implemented within the unordered HPC system fabric, generally formed from a plurality of interconnected HPC nodes that communicate with high-bandwidth connections.

The nodes 26A are configured to cooperate and share their respective memories. To that end, the example in FIG. 4 shows four nodes 26A communicating through a high-speed interconnect 402 within the unordered network 400 of the HPC system 100. Indeed, various implementations may have many more than four nodes 26A, or fewer than four nodes 26A. Moreover, while each of these nodes 26A is discussed as being implemented by the blades 26 discussed above, those skilled in the art can implement each of these nodes 26A in any of a variety of manners. Accordingly, discussion of the specific implementation of each node is illustrative and not intended to limit various embodiments.

Nodes 1-3 in this example each have at least one requesting agent 404 that each may request access to at least a portion of the memory in other nodes 26A. For example, the requesting agents 404 may request access to the (some or all of) the memory in Node 4. This memory may generically be represented as memory 195 of FIG. 1. In a corresponding manner, Node 4 has a home agent 406 that manages access to the memory 195. Among other things, the home agent 406 detects when a requesting agent 404 requests access to the memory 195, determines when conflicting requesting agents 404 require access to the memory 195, and determines how to manage such conflicts.

One important role of the home agent 406 is to ensure that data in the memory 195 remains current. For example, a first requesting agent 404 may have current ownership or control of specific data in the memory 195. If a second requesting agent 404 attempts to access that same part of memory 195, the home agent 406 preferably prevents immediate access of that memory 195 until the first requesting agent 404 has relinquished control of the data. Specifically, when the first requesting agent 404 relinquishes control, it and/or the home agent 406 update the data before storing it back in the memory 195. After the updated data is stored back in the memory 195, it is considered current and not “stale,” and thus, may be accessed by the second requesting agent 404. If, however, the second requesting agent 404 had directly access the memory 195 before the first requesting agent 404 relinquished control of the data, then the second requesting agent 404 would have received data that is not up-to-date. In other words, the data would have been “stale.”

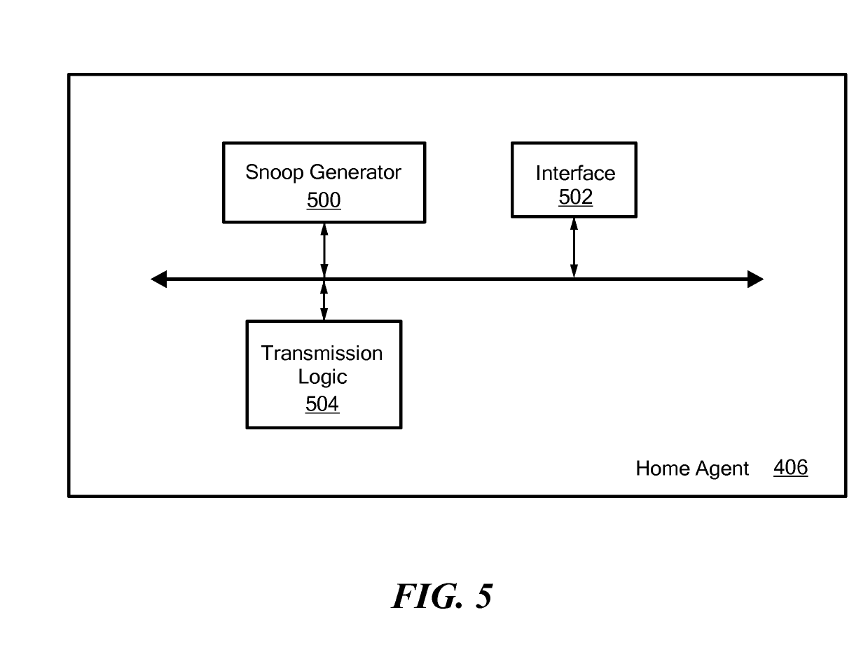

The home agent 406 therefore has a snoop generator 500, as shown in FIG. 5, to generate snoop messages that, among other things, cause a requesting agent 404 to relinquish control of specific data in the memory 195.

Continuing with the above example, the snoop generator 500 of the home agent 406 therefore forwards a snoop request to the first requesting agent 404 after it determines that the second requesting agent 404 requires access to the data.

It should be noted that all nodes 26A can have home agents 406 for managing their local memory 195. In a similar manner, all nodes 26A can have requesting agents 404 that request access to memory 195 of other nodes. Accordingly, although not shown in FIG. 4, Node 4 can have one or more requesting agents 404, while Nodes 1-3 each may have one or more home agents 406. Illustrative embodiments apply to requesting agents 404 requesting access to memory 195 on remote nodes 26A—i.e., requesting agents 404 that request access to memory 195 on nodes 26A other than their own respective nodes 26A.

FIG. 5 schematically shows more details of the home agent 406, which preferably is implemented as part of the HUB ASIC of Node 4, or as a process agent within one or more of the microprocessors of Node 4. As known by those in the art, the home agent 406 preferably is positioned near the memory 195. For example, the memory 195 may be implemented as dynamic random access memory (“DRAM”) using dual in-line memory modules (“DIMMs”) mounted near the home agent 406.

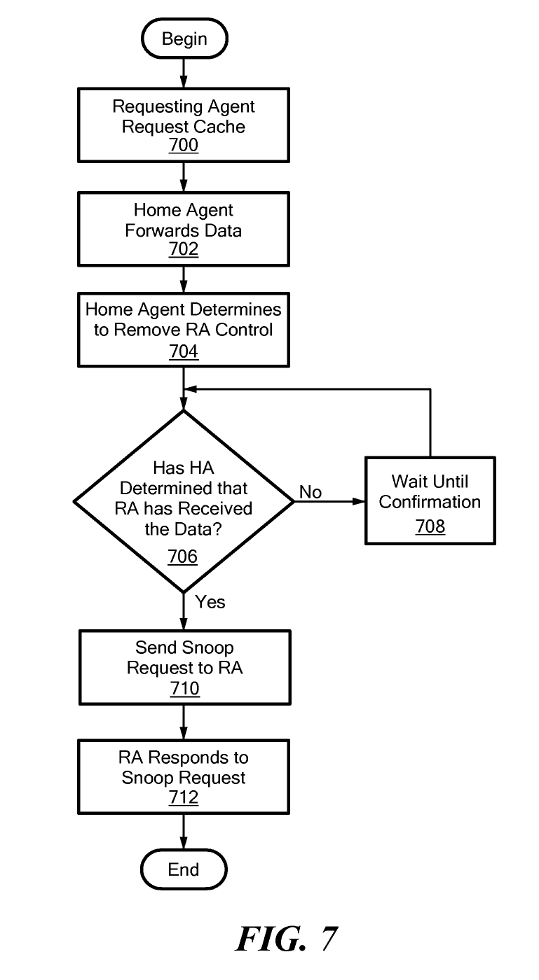

In addition to having the above noted snoop generator 500, the home agent 406 also has an interface 502 for communicating with other components (e.g., requesting agents 404), and transmission logic 504 for determining when to send data requests and snoop requests, forming data requests and snoop requests, managing conflicts between requesting agents 404, etc. (e.g., see FIG. 7). Those skilled in the art understand that the home agent 406 includes other functional modules, which are not shown for simplicity purposes only. The home agent 406 also has a component interconnection apparatus, which, in this example, is shown as a bus. It should be noted, however, that FIG. 5 shows a bus as a generic representation of an interconnection mechanism for the various functional modules of the home agent 406. Those skilled in the art are expected to make appropriate interconnections between the different functional modules based on their specific implementations.

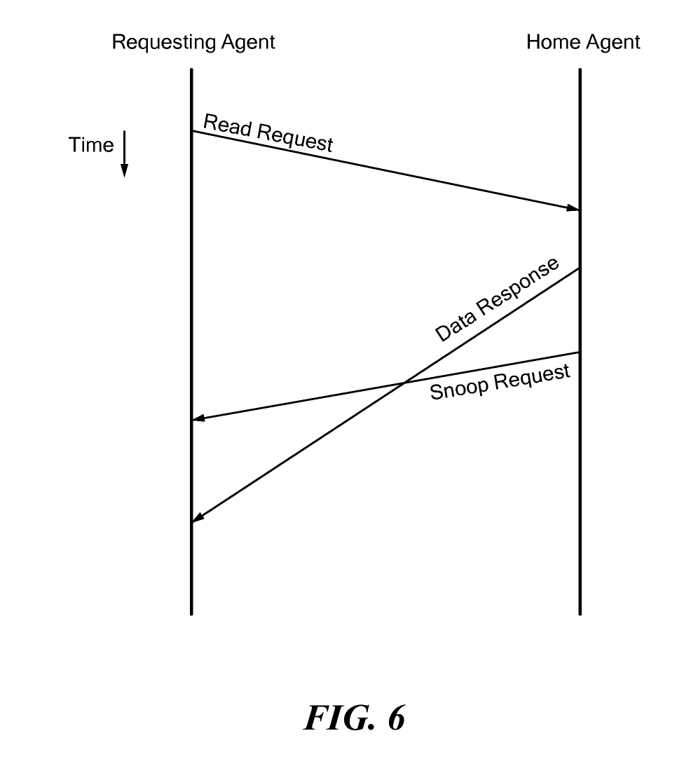

As known by those skilled in the art, a requesting agent 404 ideally receives a data response from the home agent 406 before receiving a snoop request. This is not always the case, however, with various unordered networks. FIG. 6 schematically illustrates this problem as a timing diagram, in which the requesting agent 404 sends an initial read request (requesting access to a specific part of the memory 195) to the home agent 406. The home agent 406 responds to the read request first by transmitting the data back to the requesting agent 404 with a data response. The home agent 406 subsequently determines that another requesting agent 404 needs the data and thus, transmits a snoop request shortly thereafter to the requesting agent.

In this example, however, the requesting agent 404 receives the snoop request before it receives the data it requested. It is this very problem that can cause delays and other problems in the HPC system 100 because, after receiving the snoop request, the requesting agent 404 does not have enough information to determine if the data response is in fact coming. In some prior art instances, the home agent 406 may not have sent the data response. This may cause the requesting agent 404 to pause or not even respond to the snoop request. Specifically, when a prior art requesting agent known to the inventor receives a snoop has a read request outstanding, it has two options:

1. Hold the snoop request to wait for data response, or

2. Respond to the snoop request.

The requesting agent, however, undesirably does not have enough information to know which option to choose. Undesirably, this uncertainty can substantially reduce system efficiency.

Illustrative embodiments of the invention overcome this problem by permitting the home agent 406 to forward the snoop request only: 1) If it has not sent the data response, or 2) if it has determined that the requesting agent 404 has received the data response.

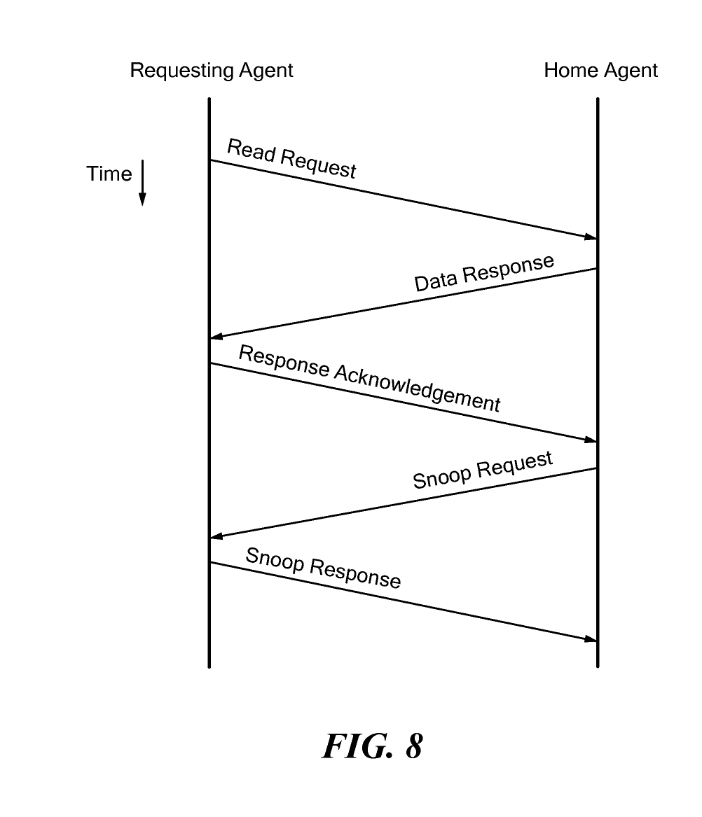

To that end, FIG. 7 shows a process of managing access to the memory 195 of Node 4 in accordance with illustrative embodiments of the invention. It should be noted that this process is a simple illustration and thus, can include a plurality of additional steps. In fact, some of the steps may be performed in a different order than that described below. Accordingly, FIG. 7 is not intended to limit various other embodiments of the invention. FIG. 8 schematically show a timing diagram illustrating the progression of the process of FIG. 7.

The process begins at step 700, in which one of the requesting agents 404 of any of Nodes 1-3 (e.g., one of the two requesting agents 404 of Node 1) requests access to the memory 195 in Node 4. For example, the requesting agent 404 may request specific data from a specific portion of the memory 195. FIG. 8 shows this request as an arrow having the heading “Read Request” pointing from the requesting agent 404 to the home agent 406.

After receiving the read request, the home agent 406 forwards the data response (see arrow pointing from the home agent 406 to the requesting agent 404 of FIG. 8) back to the requesting agent 404. This data response may have the actual data stored in the memory 195. Alternatively, the data response may have a pointer to other memory 195 having the requested data. In either case, the requesting agent 404 may process, change, or otherwise manipulate the data in that specific memory location of the memory 195 in Node 4. As noted above, until relinquished in response to a snoop request, the requesting agent 404 may be considered to “own” or “control” that portion of the data and/or memory location.

At some point in the process, however, the home agent 406 may receive request for the same data from a second requesting agent 404. For example, the requesting agent 404 of Node 3 may request access to that data. Accordingly, at step 704, the transmission logic 504 of the home agent 406 determines that it must transfer control of the specified portion of the memory 195 from the requesting agent 404 currently controlling the memory 195 (one of the requesting agents 404 of Node 1) to the requesting agent 404 of Node 3. To that end, the home agent 406 first must cause the current requesting agent 404 to relinquish control of the portion of the memory 195. After the current requesting agent 404 relinquishes control, then the home agent 406 may permit the second requesting agent 404 to own the specified portion of the memory 195.

To that end, prior art home agents 406 may have simply sent a snoop request to the current requesting agent 404, causing it to relinquish control. Illustrative embodiments, however, did not immediately send such a request. Instead, the transmission logic 504 of the home agent 406 first determines whether the current requesting agent 404 (i.e., the requesting agent 404 that currently owns the portion of memory 195) has received the data response. Those skilled in the art can use any of a number of techniques for determining if the requesting agent 404 has received the data response.

FIG. 8 schematically shows one technique, in which the requesting agent 404 forwards a response acknowledgment message to the home agent 406. Specifically, the response acknowledgment message has information indicating that the requesting agent 404 has received and/or consumed the data of the data response. Other embodiments may use other techniques for making this determination, such as by causing the home agent 406 to poll or otherwise interrogate the current requesting agent 404 having the data. Other embodiments cause the requesting agent 404 to periodically forward status messages to the home agent 406 indicating whether or not it has received the data response.

Accordingly, if the home agent transmission logic 504 determines that the requesting agent 404 has not received the data response, the process continues to step 708, in which the home agent 406 waits (i.e., delays sending the snoop request) until receiving confirmation that the requesting agent 404 has received the data response. Conversely, if the home agent transmission logic 504 determines that the requesting agent 404 has received the data response, then it forwards the snoop request to the requesting agent 404 (see FIG. 8). The current requesting agent 404 responsively forwards a snoop response message to the home agent 406, indicating that it has relinquished control of the portion of memory 195 and providing the most current data it has for that portion of memory 195 (step 712).

To improve efficiency (e.g., reduce overhead and possible congestion from the acknowledgement messages), some embodiments only execute the complete process of FIG. 7 when the home agent transmission logic 504 determines that there are multiple conflicting requests for the same memory address/memory 195. For example, when only one requesting agent 404 requests access to the specific portion of the memory 195, the home agent 406 may skip steps 706 and 708. In that case, the process may jump from step 704 to step 710. Conversely, when the home agent transmission logic 504 determines that multiple requesting agents 404 are requesting the same portion of memory 195, then the process may execute all steps.

Accordingly, for such embodiments, the data response may have an additional field indicating whether the full process of FIG. 7 is to be executed. Specifically, using the example in FIG. 8, the additional field indicates whether the requesting agent 404 is required to send a response acknowledgment to the home agent 406. For example, the data response may have a single bit field that, when set to a high value (i.e., logical “1”), causes the requesting agent 404 to send a response acknowledgment. When set to a low value (i.e., logical “0”), however, the requesting agent does not transmit the response acknowledgment. Indeed, when this bit is set to logical 0, the home agent 406 will send a subsequent snoop request without waiting for a response acknowledgement. Of course, other embodiments may use other techniques for communicating whether or not all the steps of FIG. 7 are to be executed.

Accordingly, as discussed above, the requesting agent 404 can promptly respond to a snoop request because its logic recognizes that the data response is not currently “in flight” within the fabric of the unordered network 400 from the home agent 406. Specifically, the requesting agent 404 is configured to recognize that the home agent 406 can only send the snoop request if it has not sent the data response at all, or it has not received the response acknowledgment. The requesting agent 404 therefore does not have the option of waiting for a data response because its logic recognizes that the home agent 406 did not send the data response. Removing this obstacle therefore favorably enables the HPC system 100 to more efficiently share data across multiple nodes 26A.

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as a pre-configured, stand-along hardware element and/or as preprogrammed hardware elements (e.g., application specific integrated circuits, FPGAs, and digital signal processors), or other related components.

In an alternative embodiment, the disclosed apparatus and methods (e.g., see the flow chart described above) may be implemented as a computer program product for use with a computer system. Such implementation may include a series of computer instructions fixed either on a tangible, non-transitory medium, such as a computer readable medium (e.g., a diskette, CD-ROM, ROM, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the invention may be implemented as a combination of both software (e.g., a computer program product) and hardware. Still other embodiments of the invention are implemented as entirely hardware, or entirely software.

Although the above discussion discloses various exemplary embodiments of the invention, it should be apparent that those skilled in the art can make various modifications that will achieve some of the advantages of the invention without departing from the true scope of the invention.

What is claimed is:

1. A method of accessing data in a memory in a multi-node, high performance computing system having a requesting agent and a home agent, the requesting agent being a member of a first node of the high performance computing system, the home agent being a member of a second node of the high performance computing system, the method comprising:
the requesting agent forwarding a data request to the home agent across an unordered network within the high performance computing system, the data request requesting data in specified memory of the second node of the high performance computing system;
the home agent forwarding the data in the specified memory toward the requesting agent across the unordered network;
the home agent determining that a snoop request is to be sent to the requesting agent, the snoop request to be forwarded to the requesting agent after the home agent forwards the data in the specified memory toward the requesting agent;
the home agent determining that the requesting agent has received the requested data in the specified memory of the second node;
the home agent forwarding the snoop request to the requesting agent across the unordered network in response to determining that the requesting agent has received the requested data in the specified memory.

2. The method as defined by claim 1 further comprising:
the requesting agent forwarding a snoop response message toward the home agent after receipt of the snoop request, the snoop response message indicating that the requesting agent has released control of the specified memory.

3. The method as defined by claim 1 further comprising:
the requesting agent forwarding an acknowledgement message toward the home agent across the unordered network, the acknowledgement message having information indicating that the requesting agent has received the requested data in the specified memory of the second node;
the home agent receiving the acknowledgement message, receipt of the acknowledgement message by the home agent enabling the home agent to determine that the requesting agent has received the requested data.

4. The method as defined by claim 1 wherein the high performance computing system has at least one other requesting agent, the method further comprising:
the home agent determining whether one or more of the other requesting agents are requesting access to the specified memory, the home agent responsively forwarding the snoop request without determining that the requesting agent has received the requested data in the specified memory if the home agent determines that no other requesting agents are requesting access to the specified memory.

5. The method as defined by claim 4 wherein the home agent determines whether a plurality of other requesting agents are requesting access by determining that at least one other requesting agent has requested the data in the specified memory.

6. The method as defined by claim 4 where the home agent forwards the data in the specified memory as a part of a data message having a field indicating whether one or more other requesting agents are requesting access to the specified memory.

7. The method as defined by claim 6 further comprising:
the requesting agent generating an acknowledgement message toward the home agent across the unordered network only if the field indicates that one or more other requesting agents are requesting access to the specified memory, the acknowledgement message having information indicating that the requesting agent has received the requested data in the specified memory of the second node, receipt of the acknowledgement message by the home agent enabling the home agent to determine that the requesting agent has received the requested data.

8. The method as defined by claim 1 wherein the home agent is part of a process agent within the second node, the home agent managing the specified memory of the second node.

9. The method as defined by claim 1 wherein the unordered network within the high performance computing system is configured to forward messages between agents in different nodes, the home agent not maintaining a record of the order of agent request messages relating to requests for data in the specified memory.

10. The method as defined by claim 1 wherein after receiving the data of the specified memory, the requesting agent controls processing of the data of the specified memory at least until receipt of the snoop request from the home agent, receipt of the snoop request causing the requesting agent to relinquish control of the data of the specified memory.

11. A high performance computing system comprising:
a requesting agent in a first node;
a home agent in a second node;
a specified memory in the second node;
an unordered network configured to permit electronic communication between the requesting agent and the home agent;
the requesting agent configured to forward a data request to the home agent across the unordered network within the high performance computing system, the data request requesting data in the specified memory of the second node of the high performance computing system;
the home agent configured to selectively forward the data in the specified memory across the unordered network, the home agent also configured to determine whether a snoop request is to be sent to the requesting agent, the home agent configured to hold the snoop request if i) the home agent has forwarded the data in the specified memory toward the requesting agent and ii) the home agent has not determined whether the requesting agent has received the data in the specified memory, the home agent further being configured to forward the snoop request across the unordered network after determining that the requesting agent has received the data in the specified memory.

12. The high performance computing system as defined by claim 11 wherein the requesting agent is configured to forward an acknowledgement message toward the home agent across the unordered network, the acknowledgement message having information indicating that the requesting agent has received the requested data in the specified memory of the second node, receipt of the acknowledgement message by the home agent enabling the home agent to determine that the requesting agent has received the requested data.

13. The high performance computing system as defined by claim 11 further comprising a third node, the home node configured to determine if a second requesting agent in the first node or in the third node is requesting the data in the specified memory to produce a request conflict,
the home agent configured so that if a request conflict is determined to not be produced, the home agent responsively forwards the snoop request without determining whether the requesting agent has received the data in the specified memory.

14. The high performance computing system as defined by claim 11 further comprising a third node, the home agent configured to determine if a second requesting agent in the first node or in the third node is requesting the data in the specified memory to produce a request conflict,
the home agent being configured so that if a request conflict is determined to be produced, the home agent responsively holds the snoop request if i) the home agent has forwarded the data in the specified memory toward the requesting agent and has not determined whether the requesting agent has received the data in the specified memory, the home agent being configured to forward the snoop request after determining that the requesting agent has received the data in the specified memory.

15. The high performance computing system as defined by claim 11 wherein the second node comprises a plurality of microprocessors, memory, and a control integrated circuit coupled with the microprocessors and memory, the integrated circuit controlling and coordinating operations of the second node and having an interface for communicating with the first node across a data communication bus, the control integrated circuit at least in part implementing the home agent.

16. A computer program product for use on a high performance computer system for accessing data in a memory in a multi-node, high performance computing system having a requesting agent and a home agent, the requesting agent being a member of a first node of the high performance computing system, the home agent being a member of a second node of the high performance computing system, the computer program product comprising a tangible, non-transient computer usable medium having computer readable program code thereon, the computer readable program code comprising:
program code for controlling the requesting agent to forward a data request to the home agent across an unordered network within the high performance computing system, the data request requesting data in specified memory of the second node of the high performance computing system;
program code for controlling the home agent to forward the data in the specified memory toward the requesting agent across the unordered network;
program code for controlling the home agent to determine that a snoop request is to be sent to the requesting agent, the snoop request to be forwarded to the requesting agent after the home agent forwards the data in the specified memory toward the requesting agent;
program code for controlling the home agent to determine that the requesting agent has received the requested data in the specified memory of the second node;
program code for controlling the home agent to forward the snoop request to the requesting agent across the unordered network in response to determining that the requesting agent has received the requested data in the specified memory.

17. The computer program product as defined by claim 16 further comprising:
program code for controlling the requesting agent to forward a snoop response message toward the home agent after receipt of the snoop request, the snoop response message indicating that the requesting agent has released control of the specified memory.

18. The computer program product as defined by claim 16 further comprising:
program code for controlling the requesting agent to forward an acknowledgement message toward the home agent across the unordered network, the acknowledgement message having information indicating that the requesting agent has received the requested data in the specified memory of the second node, receipt of the acknowledgement message by the home agent enabling the home agent to determine that the requesting agent has received the requested data.

19. The computer program product as defined by claim 16 further comprising:
program code for controlling the home agent to determine whether one or more other requesting agents are requesting access to the specified memory; and
program code for controlling the home agent to forward the snoop request without determining that the requesting agent has received the requested data in the specified memory if the home agent determines that no other requesting agents are requesting access to the specified memory.

20. The computer program product as defined by claim 16 wherein the unordered network within the high performance computing system is configured to forward messages between agents in different nodes, the home agent being configured not to maintain a record of the order of agent request messages relating to requests for data in the specified memory.
